(19) United States
(12) Patent Application Publication
(10) Pub. No.: US 2023/0234088 A1
(43) Pub. Date: Jul. 27, 2023

(54) PROGRAMMING METHOD FOR A COATING INSTALLATION, AND CORRESPONDING COATING INSTALLATION

(71) Applicant: Dürr Systems AG, Bietigheim-Bissingen (DE)

(72) Inventors: Hans-Jürgen Nolte, Besigheim (DE); Christoph Heckeler, Renningen (DE); Tjark Bringewat, Stuttgart (DE); Andreas Fischer, Ludwigsburg (DE); Oliver Herrmann, Sachsenheim (DE)

(21) Appl. No.: 17/926,720

(22) PCT Filed: May 10, 2021
(86) PCT No.: PCT/EP2021/062254

§ 371 Date: Nov. 21, 2022

(30) Foreign Application Priority Data
May 27, 2020 (DE) 10 2020 114 201.3

(51) Int. Cl. B05B 13/04; B25J 9/16; B05B 12/08

(52) U.S. Cl. CPC B05B 13/0431; B25J 9/1664; B25J 9/1671; B05B 12/084; G05B 2219/35343; G05B 2219/45065

(57) ABSTRACT

The disclosure relates to a method for programming a program-controlled coating installation with a coating robot and an application device for coating components, in particular for programming a painting installation with a painting robot for painting motor vehicle body components, with the following steps (S1-S3):
a) Presetting or determining geometry data of the component to be coated (S1),
b) presetting of robot path data of the robot path to be traversed (S2), and
c) determination of suitable spray pattern data (S3) which represent a layer thickness profile and are determined by a simulation which takes into account the robot path data and the geometry data of the component to be coated.

Furthermore, the disclosure comprises an appropriately adapted coating installation.

### CROSS-REFERENCE TO RELATED APPLICATIONS

This application is a national stage of, and claims priority to, Patent Cooperation Treaty Application No. PCT/EP2021/062254, filed on May 10, 2021, which application claims priority to German Application No. DE 10 2020 114 201.3, filed on May 27, 2020, which applications are hereby incorporated herein by reference in their entireties.

### FIELD

The disclosure relates to a method for programming a program-controlled coating installation, in particular for a painting installation for painting motor vehicle body components.

### BACKGROUND

In modern painting installations for painting motor vehicle body components, a rotary atomizer is usually used as the application device, which is guided by a multi-axis painting robot over the motor vehicle body components to be painted. The operation of the painting installation and thus also the control of the painting robot and the rotary atomizer is program-controlled. The painting installation must therefore be programmed prior to actual painting operation. As part of this programming, robot paths are planned offline which are to be traversed by a paint impact point of the rotary atomizer, taking into account predefined painting guidelines which specify, for example, the path spacing and the path speed. In addition, application parameters for the rotary atomizer are defined during programming, such as paint flow rate, speed, shaping air flow, etc., with these application parameters being defined in accordance with predefined painting guidelines and based on the experience of the specialist personnel. The aim of programming is, among other things, to achieve the most homogeneous possible coating thickness distribution of the paint layer on the component to be coated. During programming, the coating thickness distribution is therefore optimized by varying the application parameters and the path of the robot path in several iteration loops on the basis of painting tests on test car bodies. The disadvantage of this well-known programming method is the high cost in terms of time, paint material and test car bodies.

In a newer development line, on the other hand, which has not yet been put into practice, an attempt is being made to simulate the painting process completely physically, so that the optimization of the robot path and the application parameters can then be carried out as part of a simulation. A disadvantage of this new development line, however, is the high computational effort required within the framework of the simulation, so that the time required for the calculation has not yet been practicable.

For the general technical background of the disclosure, reference should also be made to US 2012/0156362 A1 and DE 196 51 716 A1.

The disclosure is therefore based on the task of creating an improved method for programming a program-controlled coating installation. Furthermore, the disclosure is based on the task of creating a correspondingly adapted coating installation.

### DESCRIPTION OF THE DRAWINGS

FIGS. 1A, 1B show a flow chart illustrating the programming method according to the disclosure.

FIG. 2 shows a flow chart illustrating the simulation of the coating result within the programming method according to the disclosure.

FIG. 3 shows an example of a coating thickness profile generated by a rotary atomizer.

FIG. 4 shows different coating thickness profiles with a variation of the paint flow.

FIG. 5 shows an example of a characteristic diagram for linking spray pattern data on the one hand and application parameters on the other.

FIG. 6 shows a schematic diagram of a coating installation according to the disclosure.

FIG. 7 shows a modification of FIG. 1A.

### DETAILED DESCRIPTION

The programming method according to the disclosure firstly provides for geometry data to be made available, the geometry data representing the geometry of the component to be coated (e.g. motor vehicle body component). Within the scope of the programming method according to the disclosure, the geometry data can, for example, be measured on the basis of a real component or can be specified, for example in file form.

Furthermore, the programming method according to the disclosure provides for robot path data to be specified, with the robot path data defining a robot path which is to be traversed by a paint impact point (TCP: Tool Center Point) of the application device guided by the coating robot during coating operation.

It should be mentioned here that, with regard to the type of application device, the disclosure is not limited to the rotary atomizer mentioned at the beginning. Rather, the application device can also be a print head which, in contrast to an atomizer, does not emit a spray jet of the coating agent, but a spatially narrowly limited coating agent jet. Alternatively, it is also possible within the scope of the disclosure for the application device to be an airless atomizer or an airmix atomizer, to name just a few further examples.

Furthermore, the programming method according to the disclosure provides for spray pattern data to be determined, which can also be referred to as “brush curves”, the spray pattern data representing a layer thickness profile, in particular a three-dimensional layer thickness profile, which is generated by the application device on the surface of the component around the paint impact point during real coating operation. For example, rotary atomizers generate a rotationally symmetrical, donut-shaped coating thickness profile when coating a flat component surface in an idealized manner. The spray pattern data can then reproduce the course of the coating thickness as a function of the radial distance from the paint impact point. Three-dimensional coating thickness profiles (static spray patterns) can, for example, be converted into two-dimensional coating thickness cross-sections (dynamic spray patterns), from which the spray pattern data can be determined, e.g. in a generation of a characteristic diagram. However, within the scope of the disclosure, it is also possible for the spray pattern data to represent dynamic spray patterns, such as a layer thickness cross-section along a coating path.

In the context of the disclosure, a simulation of the coating result is performed based on the spray pattern data, whereby the spray pattern data is optimized until an acceptable coating result is simulated. The acceptable spray pattern data are then stored in a first data set in order to later determine the appropriate application parameters (e.g. paint flow, shaping air flow, rotational speed of the rotary atomizer, etc.) which are suitable for the practical realization of the previously determined spray pattern data.

However, it may happen that for the given robot path even the most suitable spray pattern data do not lead to an acceptable coating result. In this case, it is useful to optimize not only the spray pattern data, but also the robot path. In one embodiment of the disclosure, it is therefore checked whether the simulated coating result with the most suitable spray pattern data leads to an acceptable coating result. If this is the case, no optimization of the robot path is required and the most suitable spray pattern data determined in the simulation can continue to be used. Otherwise, the robot path is optimized and the determination of the most suitable spray pattern data is repeated in a loop during the simulation until the simulated coating result is acceptable.

When optimizing the robot path, the following optimization measures can be carried out, for example:
Adaptation of the path course, e.g. changing the polygon courses that define the path course,
adaptation of the path distances,
shortening or lengthening of paths (e.g. at edges),
introduction of additional paths,
removal of paths,
adjustment of the orientation of the applicator axis on the robot path,
adjustment of the path speed,
change of switch-on points or switch-off points on the robot path, especially at edges, path reversal points, interfaces of painting areas of different painting robots (“painting module joints”),
optimization by brush parameterization with regard to spray jet width or diameter, spray jet shape and scaling of the paint outflow rate, and by inserting or removing brush numbers with the associated brush parameterization.

During the simulation to determine the suitable spray pattern data, properties of the atomizer and/or the bell cup shaping air ring system are preferably also taken into account, in particular with regard to possible paint outflow rates and achievable spray pattern widths.

However, data other than the spray pattern data can also be optimized as part of the simulation. For example, the robot path sequences and the paint flow on/off points can also be optimized.

The programming method according to the disclosure also provides for a simulation of the coating result, as is also the case with the prior art described at the beginning. In the coating method according to the disclosure, however, no physical simulation is carried out, which as such is considerably more complex. Rather, the simulation according to the disclosure is based on the spray pattern data and the coating thickness profiles defined thereby, so that the simulation according to the disclosure is much simpler and can therefore also be carried out in a practicable computing time.

It has already been mentioned above that after the simulation the suitable spray pattern data (brush curves) are available in a first data set. However, this spray pattern data is not yet suitable for controlling the application device. In the programming method according to the disclosure, it is therefore preferable to determine suitable application parameters (e.g. rotational speed of the rotation atomizer, paint flow, shaping air flow, etc.) from the determined suitable spray pattern data, which are suitable in practical operation to realize the previously determined suitable spray pattern data when the application device moves along the specified robot path. These suitable application parameters are then stored in a second data set.

The coating installation can then be operated with the application parameters determined in this way. During operation with the previously determined application parameters, the previously determined suitable spray pattern data are then produced in practice, which were determined as suitable on the basis of the simulation and lead to an acceptable coating result.

In one variant of the disclosure, the suitable spray pattern data are determined during the simulation on the operator side at the coating installation operator, which can be done automatically or with an assisting user intervention, for example. The first data set with the suitable spray pattern data determined during the simulation is then transferred from the operator side to a manufacturer side of the coating installation, for example to a service provider commissioned by the manufacturer of the coating installation. This service provider then uses the suitable spray pattern data transmitted by the coating installation operator to determine the suitable application parameters on the basis of a characteristic diagram and transmits these back to the coating installation operator, who then operates the coating installation with the transmitted application parameters.

In another disclosure variant, the determination of the suitable spray pattern data within the framework of the simulation also takes place on the operator side at the coating installation operator, in particular automatically or with an assisting user intervention. The coating installation operator then receives a characteristic diagram for determining the suitable application parameters, which is created on the manufacturer side, for example by a service provider commissioned by the manufacturer of the coating installation. For example, the coating installation operator can transmit coating data to the service provider that specify the coating agent to be used. The service provider commissioned by the manufacturer can then select or create an appropriate coating-specific characteristic diagram and transmit it to the coating installation operator. The operator of the coating installation then determines the suitable application parameters from the suitable spray pattern data on the basis of the characteristic diagram previously transmitted by the manufacturer.

It has already been mentioned above that the first data set contains the suitable spray pattern data which lead to an acceptable coating result in the simulation. In addition, the first data set with the suitable spray pattern data can also contain further coating data. For example, the following coating data can be mentioned at this point, which can be contained in the first data set:
The desired coating thickness of the coating agent layer on the surface of the component. This is preferably the coating thickness in the dried state as opposed to the coating thickness of the wet paint.
A coating agent identifier for identifying the coating agent and/or properties of the coating agent. For example, the coating agent identifier may indicate what solid content the coating agent used contains, or whether it is a basecoat or a clearcoat.
An application device identifier to identify the application device and/or characteristics of the application device. For example, the application device identifier may indicate which type of rotary atomizer is used.
In addition, the coating data may also include layer information to distinguish different layers in a multilayer coating.
Another example of possible coating data is the path speed of the paint impact point along the robot path, which also influences the coating result.

When determining the suitable application parameters already mentioned above, then preferably not only the spray pattern data contained in the first data set are taken into account, but also the coating data mentioned above. In addition, reference values for the path distance between adjacent coating paths, the path speed, the target layer thickness, the solids content of the coating agent and the application efficiency of the application device can also be taken into account.

It has already been mentioned above that robot path data are taken into account in the simulation, the robot path data defining the robot path to be traversed by the paint impact point of the application device in coating operation. These robot path data preferably comprise the following data:
Spatial course of the robot path,
path speed of the paint impact point along the robot path,
Path distance between laterally adjacent, laterally overlapping or adjacent path sections of the robot path,
orientation of the application device,
temporal course of the paint impact point along the robot path or speed of the paint impact point along the robot path,
switch-on points and/or and switch-off points for the paint flow, and/or
active brush number: Where is which brush number with the corresponding brush parameterization active along the robot path?

In addition, it should be mentioned that the robot path is preferably divided into several successive path sections which are to be traversed in succession by the paint impact point of the application device. The suitable spray pattern data is then preferably determined individually and specifically for the individual path sections of the robot path. In addition, a set of suitable application parameters can then also be determined individually and specifically for the individual path sections.

It has already been mentioned above that the determination of the suitable spray pattern data (brush curves) is carried out in a simulation. In the preferred embodiment of the disclosure, this simulation comprises several iteration steps which are run through one after the other and each contain optimization loops.

In a first optimization step, default values for the spray pattern and the coating agent flow are preferably specified, in particular as a percentage, relative or virtual value (reference brush). These default values serve only as starting values for the simulation of the coating result. In the course of the subsequent simulation based on the specified default values, the coating thickness distribution is then preferably determined, with deviations of the simulated coating thickness distribution from a target being determined. With regard to the layer thickness homogeneity on large component surfaces, the robot path data can already be optimized in this first optimization step.

The aforementioned initial values for the simulation can include, for example, a reference value for the path distance between the center axes of directly adjacent coating paths. For example, when painting motor vehicle body series, coating paths are usually applied to the motor vehicle body, with the coating paths running parallel to one another and overlapping laterally. The start values for the simulation can therefore also define the lateral overlap of the directly adjacent coating paths. In addition, the start values for the simulation can also include a reference value for the coating agent flow.

In a second optimization step, a test of the coating-diameter homogeneity is then preferably carried out on simple module joints. The surface of a component to be coated is usually divided into coating modules which are coated one after the other. For example, the painting modules may be the hood, roof, trunk lid, fenders and doors of a motor vehicle body, which are painted one after the other. In this case, the adjacent modules abut one another at module boundaries, simple module abutments in the sense of the disclosure being boundaries between adjacent modules at which exactly two adjacent coating modules abut one another. For example, in a motor vehicle body, the front side door and the rear side door may each form a coating module, so that the boundary between the front door and the side door forms a simple module joint. The joints between three or more adjacent coating modules, on the other hand, are referred to in the context of the disclosure as complex module joints. For example, such a complex module joint occurs at the point of a motor vehicle body where the hood, the fender, the front door and the A-pillar are adjacent to each other.

In the second optimization step, the layer thickness homogeneity at the simple module joints described above is first determined and compared with a target value. In the second optimization step, the robot path can then be optimized to optimize the layer thickness homogeneity at the simple module joints. This optimization can be done in several iteration loops, which are run successively until an acceptable improvement of the layer thickness homogeneity is achieved.

In a third optimization step, the layer thickness homogeneity can then be optimized at the complex module joints mentioned above. Here, too, the robot path can be adjusted several times during the third optimization step in order to optimize the layer thickness homogeneity at the complex module joints. In the third optimization step, this optimization can be performed in several optimization loops, which are run through one after the other until an acceptable layer thickness homogeneity is achieved at the complex module joints.

In a fourth optimization step, the layer thickness homogeneity can again be optimized at simple and/or complex module joints. However, in this fourth optimization step, it is not the robot path that is adjusted, but the spray pattern data (brush curves) and/or the coating agent flow. The optimization in the fourth optimization step can also be performed in several optimization loops, which are run through one after the other until the simulation leads to an acceptable coating result at the simple or complex module joints.

Finally, in a fifth optimization step, an optimization of the coating thickness homogeneity at component edges of the component to be coated can lead. For example, the component edges can be the edges of an engine hood to be coated or the edges of a door of a motor vehicle body to be coated. In the fifth optimization step, the coating thickness homogeneity at the component edges is simulated and compared with a specified target value for the coating thickness homogeneity. The robot path, the spray pattern data and/or the coating agent flow can then be adjusted until the simulation leads to an acceptable coating result. In the fifth optimization step, the following adjustments can be made, for example:
Optimization of the robot path: Adjustment of the path, e.g. general modification of the polygonal paths or adjustment with regard to path distances, shortening and lengthening of paths (e.g. at edges), additional paths, fewer paths, adjustment of the orientation of the bell plate axis, adjustment of the speed,
Optimization by changing switch-on points and/or switch-off points of the coating flow (GUN ON/GUN OFF), especially at edges, path reversal points, interfaces of coating areas of different robots (coating module joints),
Optimization by brush parameterization with regard to spray jet width or spray jet diameter, spray jet shape and scaling of the paint flow rate and by inserting or removing brush numbers with the associated brush parameterization.

It should be mentioned here that the above-mentioned adjustments (“set screws”) are not only possible within the framework of the fifth optimization step, but also in general. The optimization in the fifth optimization step can also be carried out in several optimization loops, which are run through one after the other until the simulation leads to an acceptable coating result at the component edges.

As part of the simulation of the coating result, the coating result can also be displayed graphically on a screen on the operator side. For example, the component to be coated can be displayed on a screen as a perspective model. The surface of the displayed model of the component to be coated can be colored depending on the location, whereby the coloring of the component surface on the screen reflects, for example, the local deviation between the simulated coating thickness on the one hand and a specified target value for the coating thickness on the other. This visualization of the simulated coating result on a screen provides the programmer with a quick and intuitive overview of the simulated coating result.

It has already been mentioned above that after determining the suitable spray pattern data (brush curves), the appropriate application parameters suitable for realizing the specified spray pattern data are determined as part of the simulation. This conversion is preferably carried out on the basis of a multidimensional characteristic diagram which can, for example, link together several of the following variables for a particular coating medium:
Width of the coating thickness profile, in particular as SB50 value of the coating thickness profile. The SB50 value here designates the width of the coating thickness profile within which the coating thickness is at least 50% of the maximum value of the coating thickness.
Shaping air flow of the application device (e.g. rotary atomizer).
Coating agent flow of the application device (e.g. rotary atomizer).
Rotational speed of the rotary atomizer used as application device.
High voltage of an electrostatic coating agent charge.
Path speed of the application device (e.g. rotary atomizer) along the robot path.
Coating distance between the application device and the surface of the component to be coated.

It has already been mentioned above that robot path data are specified, which determine the course of the robot path during the actual coating operation. This robot path data can, for example, be specified on the operator side on the basis of the geometry data of the component to be coated. Alternatively, however, it is also possible for the robot path data to be provided by the manufacturer and then read in in file form by the coating installation operator.

The same also applies to the geometry data of the component to be coated, which can, for example, be determined on the operator side by the coating installation operator as part of the measuring process. Alternatively, however, it is possible for the geometry data to be provided by the manufacturer.

In practice, it has also been shown that, with regard to the simulation method and the spray pattern data, it is advantageous to also be able to at least partially avoid spray jet distortion, for example at edges, A-pillars, etc. Special painting situations and effects, e.g. air flow in the booth, air flow around the atomizer and around the workpiece, high-voltage influences, etc., are therefore automatically taken into account in the simulation—if necessary—e.g. at workpiece edges, recesses for sunroofs or complex workpiece geometries.

Furthermore, it should be mentioned that the disclosure does not only claim protection for the above described programming method according to the disclosure. Rather, the disclosure also claims protection for a correspondingly adapted coating installation which is suitable for carrying out the programming method according to the disclosure.

In accordance with the state of the art, the coating installation according to the disclosure initially comprises at least one coating robot, at least one application device (e.g. rotary atomizer) and a control which controls the application device and the coating robot. In the coating installation according to the disclosure, the control is then designed to execute the programming method according to the disclosure.

For example, the aforementioned characteristic diagram can be stored in the control in order to determine the suitable application parameters from the suitable spray pattern data.

In addition, the coating installation according to the disclosure preferably has a data interface for transmitting the spray pattern data and/or the coating data to the coating installation manufacturer or a service provider commissioned by him and for receiving the associated characteristic diagram for determining the suitable application parameters from the coating installation manufacturer or the service provider.

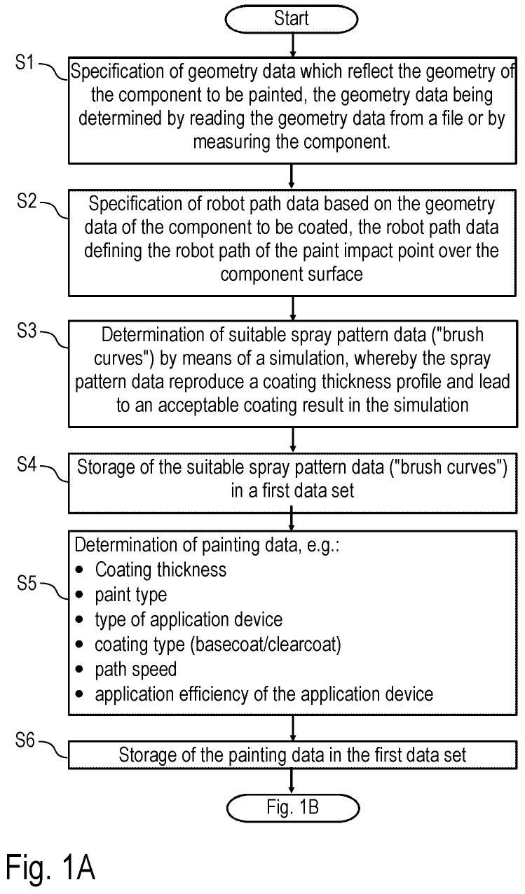

The flow diagram according to FIGS. 1A and 1B, which illustrates the programming method according to the disclosure, is now described below.

In a first step S1, geometry data are first specified which reflect the geometry of the component to be painted (e.g. motor vehicle body component). The geometry data can, for example, be provided in file form and easily read out. Alternatively, however, it is also possible for the geometry data to be measured using a real component.

In a second step S2, robot path data is then provided, with the robot path data defining the path of movement of the paint impact point of the application device used on the component surface. The robot path data is determined on the basis of the geometric data of the component to be coated. Coating guidelines are usually taken into account here, which may, for example, contain specifications regarding the lateral distance between adjacent coating paths and regarding the lateral overlap of the adjacent coating paths.

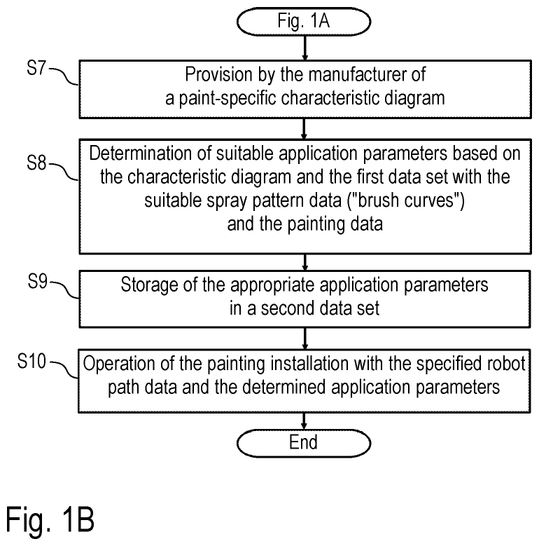

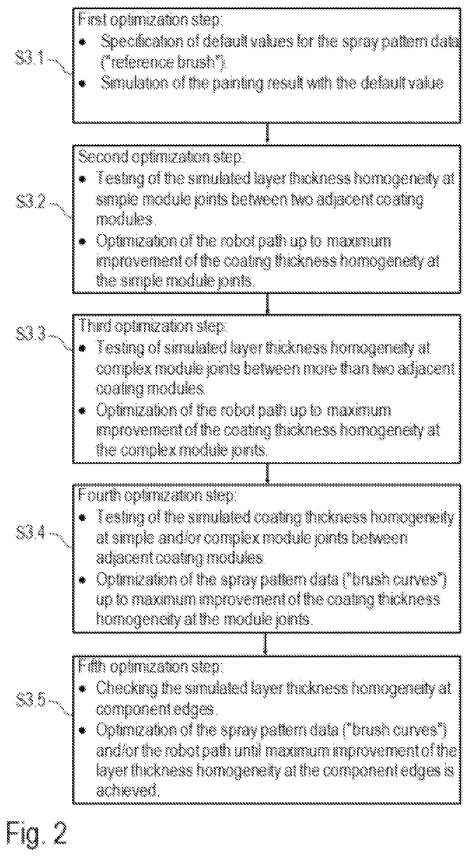

In a further step S3, suitable spray pattern data (brush curves) are then determined in a simulation, with the spray pattern data representing a coating thickness profile and leading to an acceptable coating result in the simulation. For example, FIG. 3 shows a coating thickness profile of a rotary atomizer with several spray pattern data characterizing the coating thickness profile. The most important value for describing the coating thickness profile here is the SB50 value, which reflects the width of the coating thickness profile within which the coating thickness is at least 50% of the maximum coating thickness SD_{MAX}. The simulation in step S3 will be described in detail later with reference to FIG. 2.

The acceptable spray pattern data determined in the simulation are then stored in a first data set in a step S4.

In a further step S5, additional coating data is then determined, such as the desired coating thickness, the coating type, the application device type, the coating type (basecoat/clearcoat), the path speed and the application efficiency of the application device. This coating data is then stored in the first data set together with the spray pattern data in a step S6.

In a step S7, a coating-specific characteristic diagram is then provided by the manufacturer so that the associated application parameters can be determined from the suitable spray pattern data, which in practice lead to the realization of the suitable spray pattern data.

In the next step S8, the characteristic diagram is then used to determine the suitable application parameters from the suitable spray pattern data and the paint data. For example, the application parameters may include the shaping air flow of a rotary atomizer, the high-voltage charging, and the paint flow.

The appropriate application parameters are then stored in a second data set in a step S9.

In the next step S10, the painting installation is then operated with the specified robot path data and the determined application parameters. In the case of an optimally calculated characteristic diagram, the operation of the painting installation with the application parameters read from the characteristic diagram then leads to the spray pattern data previously determined in the simulation, so that a good match can be achieved between simulation and real painting operation.

It should be mentioned here that the programming method described above can determine the spray pattern data and the associated application parameters individually for different path sections on the robot path. This means that the application parameters do not have to be constant along the robot path. Rather, the application parameters can be varied along the robot path in order to achieve a good coating result.

In the following, the simulation according to step S3 in FIG. 1A will be described in more detail, referring to the flow chart in FIG. 2.

In a first step S3.1 of the simulation, default values for the spray pattern dimensions are first specified, which can also be referred to as the reference brush. Subsequently, the coating result is simulated on the basis of the specified default values.

In a second optimization step S3.2, the coating thickness homogeneity is then tested at simple module joints between two adjacent modules. In the context of the disclosure, the term simple module joints refers to the boundaries between exactly two adjacent coating modules. For example, the boundary between the front side door and the rear side door forms such a simple module joint. The robot path is then optimized in the context of the simulation until a maximum improvement of the coating thickness homogeneity at the simple module joints is achieved. The second optimization step S3.2 can thus comprise several iteration loops which are run through one after the other. It is important here that the layer thickness homogeneity at the simple module joints is evaluated and used to optimize the robot path.

In a third optimization step S3.3, the layer thickness homogeneity at complex module joints between more than two adjacent coating modules can then be checked. The term complex module joints refers to the boundaries between more than two adjacent coating modules. For example, the boundary between the fender, the hood, the front side door and the A-pillar of a motor vehicle body constitutes such a complex module joint. In the third optimization step S3.3, the robot path is again optimized iteratively until a maximum improvement in layer thickness homogeneity is achieved at the complex module joints.

In a fourth optimization step S3.4, the layer thickness homogeneity at the complex and/or simple module joints is again determined and used as an optimization criterion. However, it is not the robot path that is optimized, but the spray pattern data (brush curves), until a maximum improvement in the layer thickness homogeneity at the simple or complex module joints is achieved.

In a fifth optimization step S3.5, the coating thickness homogeneity at the component edges is then checked and used as an optimization criterion. For example, the layer thickness homogeneity at the edges of an engine hood can be checked and taken into account. During optimization, the spray pattern data and/or the robot path can then be optimized until maximum improvement of the layer thickness homogeneity at the component edges is achieved. Here, too, the optimization can comprise several iteration loops which are run through one after the other.

FIG. 3 shows a film thickness profile typically generated by a rotary atomizer.

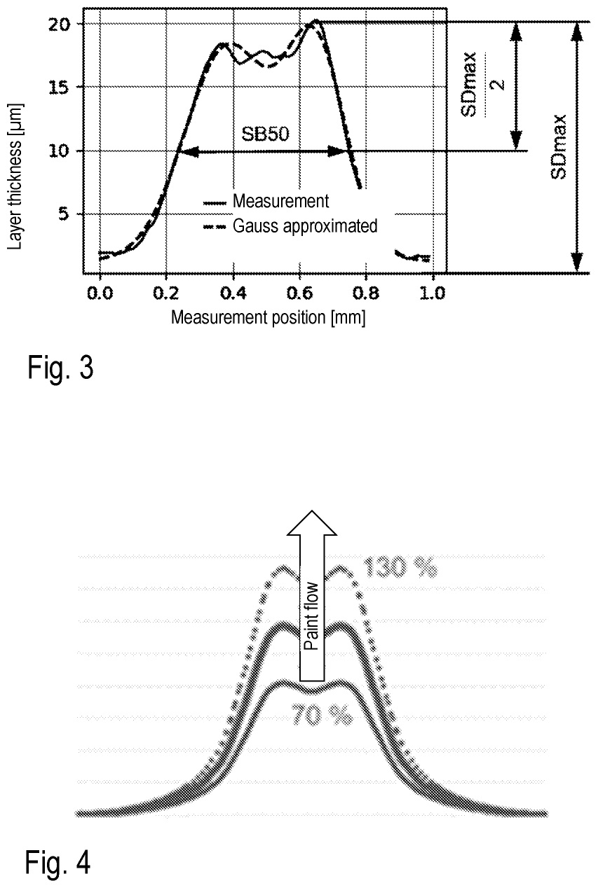

FIG. 4 shows a corresponding film thickness profile of a rotary atomizer when the paint flow is changed from 70% to 130%.

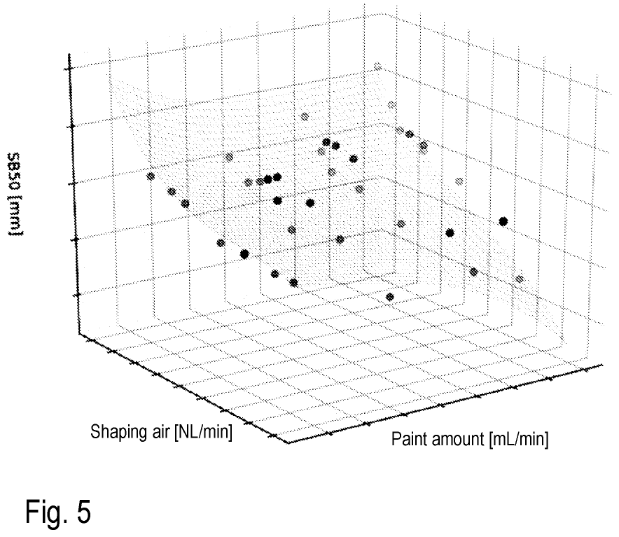

FIG. 5 shows a characteristic diagram which can be used in the context of the disclosure to determine suitable application parameters from the spray pattern data. The spray pattern data in the characteristic diagram shown in FIG. 5 is the SB 50 value, while the application parameters are the air flow and the paint flow rate. Within the scope of the disclosure, however, multi-dimensional characteristic diagrams can also be used which link a larger number of spray pattern data or application parameters.

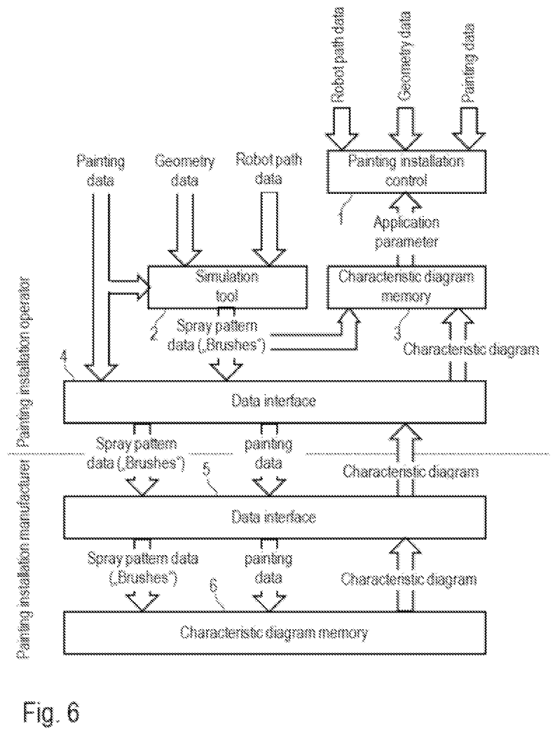

FIG. 6 shows, in a highly simplified and thematized form, a painting installation according to the disclosure which is suitable for carrying out the programming method according to the disclosure.

Thus, the painting installation according to the disclosure comprises first of all, in accordance with the known painting installations, a painting installation control 1, which in operation controls a painting robot and an application device (e.g. rotary atomizer) with certain application parameters. The painting installation control 1 receives robot path data as input variables, which specify the course of a robot path, whereby the robot path data can be specified according to painting guidelines.

In addition, the painting installation control 1 receives geometry data that reflect the geometry of the component to be coated.

Finally, the coating installation control 1 receives coating data that reflect, for example, the type of coating used.

In painting operation, the painting installation control 1 then controls the painting robot and the application device accordingly, using application parameters that are determined by the programming method according to the disclosure.

For this purpose, a simulation tool 2 is provided, which also receives the painting data, the geometry data and the robot path data, and determines suitable spray pattern data as part of a simulation, which leads to an acceptable coating result in the simulation, as described above.

Furthermore, the painting installation has a characteristic diagram element 3 to determine the application parameters for the painting installation control 1, as will be described in detail.

The painting installation according to the disclosure now additionally has a data interface 4 which is used to transmit the suitable spray pattern data and the painting data to the painting installation manufacturer or a service provider commissioned by the latter, which also has a data interface 5 for this purpose. On the manufacturer's side, a suitable characteristic diagram can then be read out of the transmitted painting data and the transmitted spray pattern data from a characteristic diagram memory 6 and transmitted to the painting installation operator, who then stores the suitable characteristic diagram in the characteristic diagram memory 3. The characteristic diagram stored in the characteristic diagram memory 3 then enables the suitable application parameters to be determined from the simulated spray pattern data.

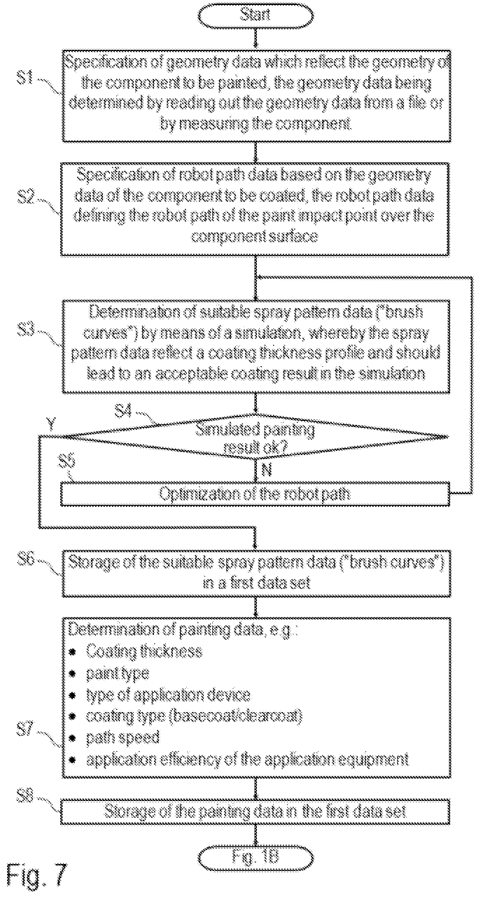

FIG. 7 shows a modification of the flow chart according to FIG. 1A, so that reference is first made to the above description of FIG. 1A in order to avoid repetition.

A special feature of this modification consists in the process steps S4 and S5, which are inserted into the process sequence. Thus, the method according to FIG. 1A assumes that the robot path is fixed and is not changed during the simulation. However, it can happen that for a certain, fixed robot path, even the best possible spray pattern data (“brush curves”) do not lead to an acceptable coating result. This can be the case, for example, if the specified robot path is particularly demanding in terms of coating technology. In such cases, it makes sense to optimize the robot path as well.

In step S4, therefore, after the best possible spray pattern data have been determined, a check is made to determine whether the simulated coating result is acceptable. If this is the case, the procedure can be continued with step S6 as described above with reference to FIG. 1A.

If, on the other hand, the simulated painting result is not acceptable even with the best possible spray pattern data, the robot path is optimized in step S5 and steps S3, S4 and S5 are repeated until the simulation with the best possible spray pattern data and the optimized robot path leads to an acceptable coating result. If this is the case, it is possible to proceed to step S6 as already described above with reference to FIG. 1A.

1.-16. (canceled)

17. A Method for programming a program-controlled coating installation with a coating robot and an application device for coating components, comprising:
a) Specifying geometry data, the geometry data representing the geometry of the component to be coated,
b) specifying robot path data,
b1) the robot path data defining a robot path which is to be traversed by a paint impact point of the application device guided by the coating robot in coating operation, and
b2) the robot path being defined on the basis of the predetermined geometry data of the component to be coated,
c) determination of suitable spray pattern data,
c1) the spray pattern data representing a layer thickness profile, which is generated by the application device on the surface of the component around the paint impact point in real coating operation, and
c2) wherein the determined spray pattern data are intended to achieve an acceptable coating result in real coating operation when coating the component along the robot path,
c3) said suitable spray pattern data being determined by a simulation which takes into account the robot path data and the geometry data of the component to be coated, and
c4) wherein the suitable spray pattern data are stored in a first data set.

18. The method according to claim 17, further comprising:
a) checking the simulated coating result after determining the possible spray pattern data,
b) optimization of the given robot path if the check shows that the coating result is not acceptable,
c) repeating the determination of the possible spray pattern data and the optimization of the robot path until the simulated coating result is acceptable.

19. The method according to claim 17, further comprising:
a) determining suitable application parameters for operating the application device ,
a1) wherein the suitable application parameters are determined from the spray pattern data contained in the first data set on the basis of a characteristic diagram,
a2) wherein the determined suitable application parameters lead to the suitable spray pattern data during real operation of the application device when the robot path is traversed, and
a3) wherein the suitable application parameters are stored in a second data set, and
b) operating the coating installation,
b1) wherein the coating robot is controlled according to the robot path data so that the paint impact point of the application device traverses the predetermined robot path on the surface of the component to be coated, and
b2) wherein the application device is controlled with the suitable application parameters contained in the second data set.

20. The method according to claim 19, wherein
a) the determination of the suitable spray pattern data takes place within the framework of the simulation on the operator side at the coating installation operator,
b) the first data set with the suitable spray pattern data determined in the course of the simulation is transferred from the operator side to a manufacturer side of the coating installation,
c) the determination of the suitable application parameters is carried out on the manufacturer's side on the basis of the characteristic diagram and the suitable spray pattern data, and
d) the second data set with the suitable application parameters is transmitted from the manufacturer side to the operator side.

21. The method according to claim 19, wherein
a) the determination of the suitable spray pattern data is carried out within the framework of the simulation on the operator side at the coating installation operator,
b) the characteristic diagram for determining the suitable application parameters is created on the manufacturer's side,
c) the characteristic diagram for determining the suitable application parameters is transmitted by the service provider to the operator side, and
d) the determination of the suitable application parameters is carried out on the operator side on the basis of the characteristic diagram and the suitable spray pattern data.

22. The method according to claim 17, wherein
a) the first data set with the suitable spray pattern data also contains at least some of the following coating data:
a1) the desired coating thickness of the coating agent layer on the surface of the component,
a2) a coating agent identifier for identifying the coating agent and/or properties of the coating agent,
a3) an application device identifier for identifying the application device and/or properties of the application device,
a4) layer information for distinguishing between different layers in a multilayer coating,
a5) path speed of the paint impact point along the robot path, and
b) in determining the suitable application parameters, not only the spray pattern data contained in the first data set are taken into account, but also the coating data contained in the first data set and preferably also a reference value for the path spacing, a reference value for the path speed, the target layer thickness, the solids content of the coating agent and the application efficiency of the application device as an assumed empirical value.

23. The method according to claim 17, wherein the robot path data contain at least some of the following data:
a) spatial course of the robot path,
b) path speed of the paint impact point along the robot path,
c) path spacing between laterally adjacent, laterally overlapping or adjacent path sections of the robot path,
d) alignment of the application device,
e) temporal course of the paint impact point along the robot path or speed of the paint impact point along the robot path,
f) switch-on points and/or and switch-off points for the paint flow.

24. The method according to claim 22, further comprising the following steps in the simulation:
a) Subdivision of the robot path into a plurality of successive path sections which are to be traversed in succession by the paint impact point of the application device,
b) determination of a suitable spray pattern for the individual path sections of the robot path,
c) determination of a suitable coating agent flow for the individual path sections of the robot path,
d) wherein the first data set with the suitable spray pattern data for the individual path sections of the robot path each contain the suitable spray image and the suitable coating agent flow.

25. The method according to claim 23, wherein the simulation is carried out in the following iterative optimization steps:
a) in a first optimization step, specification of default values for the spray pattern and the coating agent flow, and
b) in a second optimization step, testing the coating thickness homogeneity at simple module joints between exactly two adjacent coating modules on the surface of the component to be coated and optimizing the robot path to improve the coating thickness homogeneity at the simple module joints, and
c) in a third optimization step, testing the layer thickness homogeneity at complex module joints between more than two adjacent coating modules on the surface of the component to be coated and optimizing the robot path to improve the layer thickness homogeneity at the complex module joints, and
d) in a fourth optimization step, testing of the coating thickness homogeneity at simple and/or complex module joints between adjacent coating modules on the surface of the component to be coated and optimization of the following variables for improving the coating thickness homogeneity at the simple and/or complex module joints:
d1) spray pattern data, and
d2) coating agent flow,
and
e) in a fifth optimization step, testing of the coating thickness homogeneity at component edges of the component to be coated and optimization of the following variables for improving the coating thickness homogeneity at the component edges:
e1) Robot path,
e2) spray pattern data, and
e3) coating agent flow.

26. The method according to claim 24, wherein the default values for the first optimization step of the simulation are specified as a function of the following variables:
a) reference value for the path distance between center axes of directly adjacent coating paths,
b) overlap of directly adjacent coating paths, and
c) reference value for the coating agent flow.

27. The method according to claim 17, wherein the simulated coating result is represented graphically on a screen on the operator side.

28. The method according to claim 27, wherein the simulated coating result is represented with a perspective representation of the component to be coated as a model and with a location-dependent coloring of the surface of the represented model as a function of the simulated local coating thickness.

29. The method according to claim 17, wherein the characteristic diagram for determining the suitable application parameters in relation to a specific coating agent and/or the coating device used links the following variables with one another:
a) Width of the coating thickness profile,
b) shaping air flow of the application device,
c) coating agent flow of the application device,
d) rotational speed of a rotary atomizer used as application device,
e) high voltage of an electrostatic coating agent charge,
f) path speed of the application device along the robot path,
g) coating distance between the application device and the surface of the component to be coated.

30. The method according to claim 17, wherein
a) the robot path data are specified on the operator side at the coating installation operator, and
b) the geometry data of the component to be coated is specified on the operator side by the coating installation operator.

31. A Coating installation for coating components, having
a) at least one coating robot,
b) at least one application device which is guided by the coating robot, and
c) a control which controls the application device and the coating robot,
d) wherein the control is adapted to execute the method according to claim 17.

32. The coating installation according to claim 31, wherein the characteristic diagram is stored in the control in order to determine the suitable application parameters from the suitable spray pattern data.

33. The coating installation according to claim 31, further comprising a data interface for transmitting the first data set with the suitable spray pattern data to the service provider and for receiving the second data set with the suitable application parameters from the service provider.
